(19) United States
(12) Patent Application Publication
(10) Pub. No.: US 2021/0056587 A1
(43) Pub. Date: Feb. 25, 2021

(54) SYSTEM AND METHOD FOR ENHANCED WEBSITE VISITOR NOTIFICATIONS

(71) Applicant: Introhive Services Inc., Fredericton (CA)

(72) Inventors: Jody GLIDDEN, Miami Beach, FL (US); Mike WAUGH, Hanwell (CA); Jacob O'REILLY, Fredericton (CA); Tony SHEEHAN, Saint John (CA); Karen COLPITTS, Rothesay (CA)

(21) Appl. No.: 16/997,736

(22) Filed: Aug. 19, 2020

Related U.S. Application Data
(60) Provisional application No. 62/889,846, filed on Aug. 21, 2019.

(51) Int. Cl. G06Q 30/02; H04L 29/08; H04L 29/12

(52) U.S. Cl. CPC G06Q 30/0246; H04L 61/2007; H04L 67/22; G06Q 30/0201

(57) ABSTRACT

Method and system that includes: receiving, from a first automated service, identifying information for a website visitor; requesting, from a second automated service, further identifying information based on the received identifying information; when further identifying information is received from the second automated service, providing a query to a customer data storage system for an account that matches the further identifying information; and when a positive response to the query indicating a match is received from the customer data storage system, causing a notification to be generated that includes information included in the positive response.

### CROSS-REFERENCE TO RELATED APPLICATIONS

This application claims the benefit of and priority to the following application, the contents of which are incorporated herein by reference: U.S. Provisional Patent Application No. 62/889,846 entitled “SYSTEM AND METHOD FOR ENHANCED WEBSITE VISITOR NOTIFICATION”, filed Aug. 21, 2019

### TECHNICAL FIELD

The present disclosure relates to systems and methods for processing digital information from Website Traffic, enriching this information with opportunity details and providing the information to the appropriate contact in real-time.

### BACKGROUND

Enterprises such as companies, accounting firms, law firms, universities, partnerships, agencies and governments commonly use Customer Relationship Management systems (hereinafter referred to as CRM) and related technology to manage relationships and interactions with other parties such as customers and potential customers.

Most enterprises today maintain an internet website. This internet website typically consists of a combination http\https pages and forms and functions as a public repository of information on the enterprise and their services, as well as a potential initial point of contact with the enterprise. If the internet website performs as intended, it would receive a high number of web page hits\visits (or traffic) a day.

It can be challenging to collect, analyze and distribute information about website visits. Challenges can arise with: identifying who is making these website visits; if a website visitor can be identified, turning that information into something more useful than a generic data report\analytics; and presenting this information to the correct person in a timely manner. Typical traffic website monitoring systems are capable of generating regular reports, but these reports must be reviewed and the reviewer must sort out if/who should react to the information and how.

There are solutions that exist today that use website visitor IP information (among other sources of information) to determine which company visited the website. These solutions have built in reports, often showing geographic (country/state) of those visiting the website.

The foregoing examples of the related art and limitations thereto are intended to be illustrative and not exclusive. Other limitations of the related art will become apparent to those of skill in the art upon a reading of the specification and a study of the drawing.

### SUMMARY

Accordingly to a first example aspect is a computer implemented method that includes: receiving, from a first automated service, identifying information for a website visitor; requesting, from a second automated service, further identifying information based on the received identifying information; when further identifying information is received from the second automated service, providing a query to a customer data storage system for an account that matches the further identifying information; and when a positive response to the query indicating a match is received from the customer data storage system, causing a notification to be generated that includes information included in the positive response.

### BRIEF DESCRIPTION OF DRAWINGS

Exemplary embodiments are illustrated in the referenced figures of the drawings. It is intended that the embodiments and figures disclosed herein are to be considered illustrative rather than restrictive.

FIG. 1 is a simplified block diagram illustrating an environment that includes an enterprise network, enterprise website, CRM support system and 3^{rd} party data services in accordance with an example embodiment of the present disclosure.

FIG. 2 is a flow diagram illustrating steps taken by a contact identification module and communication processing module of a contact support agent in accordance with an example embodiment of the present disclosure.

FIG. 3 is an illustration of a sample of the output from a communication processing module.

FIG. 4 is a simplified block diagram illustrating an example computer system for implementing one or more of the systems, modules and components shown in the environment of FIG. 1.

### DESCRIPTION

The following embodiments and aspects thereof are described and illustrated in conjunction with systems, tools and methods which are meant to be exemplary and illustrative, not limiting in scope. In various embodiments, the above-described limitations has been reduced or eliminated, while other embodiments are directed to other improvements.

Example embodiments are directed to improved processing of information about website visits that can provide enhanced information and direct that information to the most appropriate users within an enterprise. In example embodiments, information available from an enterprise's website and 3^{rd} party data services companies is compared to and supplemented with contact relationship data that is tracked by the enterprise. Using this comparison, in an example embodiment, enables the employee with the strongest relationship with the identified company/contact to be identified and then informed that a contact is currently viewing the website. This can be an improvement over existing systems in which a random person whose job it is to act as a website contact is tasked with interfacing with website visitors.

In some alternate embodiments the 3^{rd} party data service is replaced with an internal service on the enterprise network that can identify IP addresses of visitors and where that IP address is associated with.

In some example embodiments, instead of, or in addition to notifying an employee with the strongest relationship with a website vaster, a notification may be to an internal company message board or electronic messaging system identifying that someone from company A has visited the enterprise website.

In example embodiments, a predetermined communication policy defines a set of rules that specify how and to whom information about website visits is disseminated within an enterprise. This policy can be based on, but not limited to, contact company, region, industry type or title of contact (when it can be determined). This policy can also define the type of notification such as, but not limited to, email, text or private message on an electronic messaging system.

An example of a communication policy would be: notify the enterprise CEO via Text if the visitor's IP Address was identified as one belonging to an investment organization.

Another example of a communication policy would be: notify the north-eastern sales manager via email if the visitor's IP Address was identified as originating within the north-east region of the country.

In example embodiments, a predefined contact matching policy can define threshold criteria that trigger when action is taken in respect of a website visit. For example, a contact matching may set threshold criteria with regards to, but not limited to, length of visit, number of visits within a set period of time, number of pages visited or a specific page view. Meeting the contact matching policy criteria could trigger an automated request to a 3^{rd} party data service to obtain details on the visitor.

The foregoing examples are intended to be illustrative and not exclusive. Other aspects will become apparent to those of skill in the art upon further reading of the specification and a study of the drawings.

Throughout the following description, specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

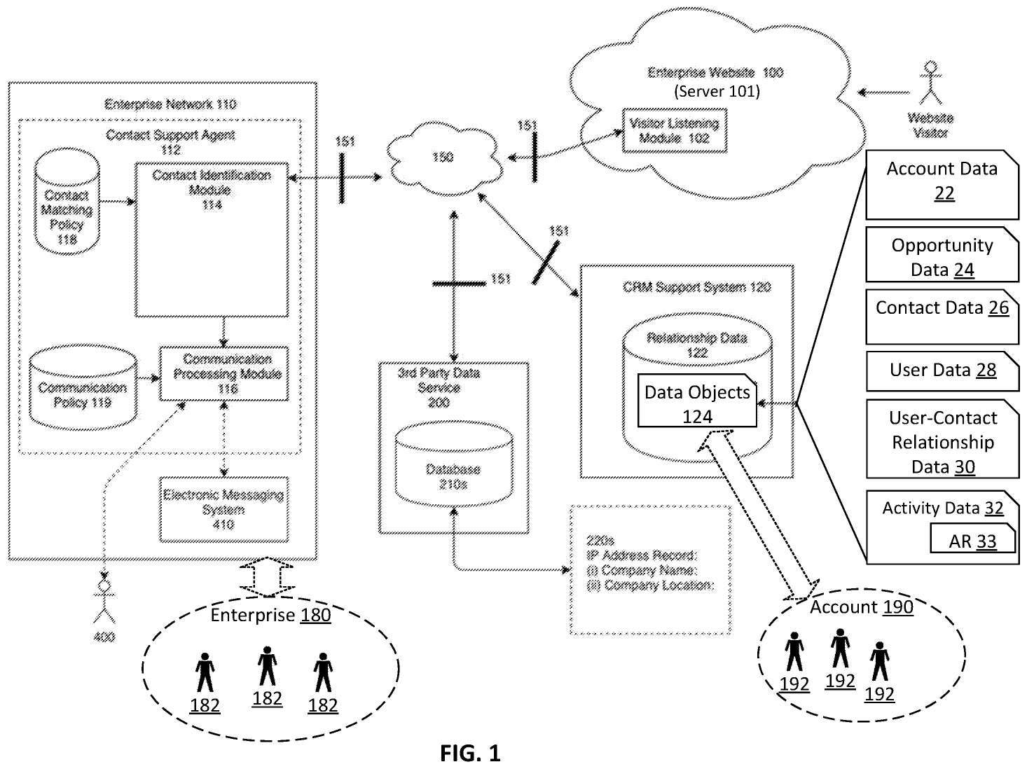

FIG. 1 is a simplified block diagram illustrating an environment that includes an enterprise network 110, enterprise website 100 (hosted by a website server 101), CRM support system 120 and 3^{rd} party data services 200, in accordance with an example embodiment of the present disclosure. Each of enterprise network 110, CRM support system 120, website server 101 and 3^{rd} party data services 200 may, for example, include a plurality of computer devices, servers and systems that are linked to each other through one or more internal or external communication networks.

Enterprise network 110 supports an enterprise 180 such as a company, firm or other type of organization (referred to in this disclosure as “enterprise 180”). In example embodiments, a plurality of individuals are registered or otherwise associated with the enterprise network 110 as users 182 of the enterprise 180. These individual users 182 may for example be employees, owners, partners, consultants, volunteers, and interns of the enterprise 180.

At any given time the enterprise 180 has, or is, pursuing commercial relationships with one or more external entities, referred to in this disclosure as “accounts” 190. For example, such external entities could be existing or potential customers, clients or donors or other entities of interest to the enterprise, and may include, among other things, companies, partnerships, universities, firms, government entities, joint venture groups, non-government organizations, charities and other types of groups. In some examples, a large customer organization may have multiple divisions or groups that each are treated as a respective account 190 by enterprise 180. Typically, each account 190 will have an associated set of individual contacts, referred to in this disclosure as “contacts” 192. For example, the individual contacts 192 associated with an account 190 may be employees, owners, partners, consultants, volunteers, and interns of the account 190.

One or more of CRM support system 120, enterprise website 100, and 3^{rd} party data services 200 may, in some examples, be operated by third party organizations that are service providers to the enterprise 180 associated with enterprise network 110. CRM support system 120 is configured to track customer data on behalf of enterprise 180, and enterprise website 100 can be a website that functions as the enterprises virtual presence on the Internet.

In the illustrated example, enterprise network 110, enterprise website 100, contact support agent 112, CRM support system 120, and 3^{rd} party data service 200 are each connected to a common communication network 150. Communication network 150 may for example include the Intranet, one or more enterprise intranets, wireless wide area networks, wireless local area networks, wired networks and/or other digital data exchange networks. Respective firewalls 151 may be located between the communication network 150 and each of the enterprise network 110, enterprise website 100, contact support agent 112, CRM support system 120, and 3^{rd} party data service 200. In different example embodiments, one or more of the features or functions of CRM support system 120 and 3^{rd} party data service 200 that are described herein could be alternatively be implemented in a common system or implemented within the enterprise network 110.

In example embodiments, CRM support system 120 is configured to provide enhanced CRM information and functionality for enterprise 180. CRM support system 120 includes a relationship data storage 122 for storing relationship data generated in respect of the accounts 190 of interest to enterprise 180. In example embodiments, relationship data storage 122 may store, in respect of each account 190, relationship data objects 124 that include: (I) account data 22 that provides general information about the account 190, (II) opportunity data 24 about specific opportunities that the enterprise has undertaken in the past, is currently undertaking, or is proposing to undertake in the future with the account 190, (III) individual contact data 26 that includes contact information for individual contacts 192 (e.g., employees) who are associated with the account 190, (IV) user data 28, that includes information about enterprise users 182 who are involved in the relationship with an account 190, (V) user-contact relationship data 30, and (VI) activity data 32 that includes information about activities between enterprise 180 and account 190.

In example embodiments, the CRM Support System 120 is configured to communicate with contact support agent 112 of enterprise network in order to update and maintain the contents of relationship data storage 122. In some examples, CRM support system 120 is configured to periodically refresh (e.g., for example on a timed cycle such an once every 24 hours) the content of data objects 124 such that the data maintained in relationship data storage 122 always includes current or near-current information.

In example embodiments, the basic data included in account data 22 stored at relationship data storage 122 may include, for an account 190, some or all of the fields listed in the following Table 1, among other things:

TABLE 1
Account Data Fields:

| Field | Field Description |
|---|---|
| Enterprise ID | Unique identifier assigned to Enterprise |
| | 180 |
| Account ID | Unique identifier assigned to Account |
| | 190 |
| Account Industry Code | Code that identifies primary industry |
| | type of customer organization (e.g., |
| | Standard Industrial Classification (SIC) |
| | Code and/or North American Industry |
| | Classification System (NAICS) Codes) |
| Number of Employees | Number of Employees of Account |
| | Organization |
| Account Size Score | Score assigned based on size of |
| | account organization (e.g., organization |
| | size of 1500 += 10 points; 1000 to |
| | 1500 = 9 points; 750-1000 = 8 points, |
| | etc.). |
| Account Annual Revenue | Annual Revenue of account |
| | organization for one or more previous |
| | years |
| Owner User ID | User ID of enterprise user 182 who |
| | owns the account (e.g., user 182 who |
| | has primary responsibility for |
| | enterprise-account relationship) |
| Name | Name of Account ( e.g., company |
| | name) |
| Top User-Account Relationship | The enterprise user 182 that has the |
| | strongest relationship with the account |
| | 190 |
| Account Active Indicator | Indicates that Account is currently |
| | active |

In example embodiments, the basic data included in opportunity data 24 stored at relationship data storage 100 may include, for each opportunity with account 190, opportunity records that include some or all of the fields listed in the following Table 2:

TABLE 2
Opportunity Data Fields:

| Field | Field Description |
|---|---|
| Opportunity ID | Unique identifier assigned to |
| | Opportunity |
| Account ID | Account ID of the account that is the |
| | target of the opportunity |
| Created Date | Date opportunity registered with CRM |
| | support system |
| Closed Indicator | Indicates if opportunity is closed |
| Closed Date | Date Opportunity was closed |
| Won Indicator | Indicates opportunity closed |
| | successfully (e.g., with a sale) |
| Main Contact ID | Contact ID of lead contact for |
| | opportunity with the account |
| Main User ID | Contact ID of lead user for opportunity |
| Last Activity Date | Date of most recent activity recorded in |
| | respect of opportunity |

In example embodiments, the basic data included in contact data 26 stored at relationship data storage 122 may include, for each contact 192 at account 190, contact records that include some or all of the fields listed in the following Table 3, among other things:

TABLE 3
Contact Data Fields:

| Field | Field Description |
|---|---|
| Contact ID | Unique contact identifier |
| Date Created | Date contact added |
| Account ID | Account ID of the account the contact is |
| | associated with |
| Department | Name of contact's department in the |
| | account organization |
| Title | Title/position of contact within account |
| | organization |
| Title Score | Score assigned to Contact based on |
| | contact's position at the account |
| | organization |
| Contact -Enterprise | Score That Indicates Perceived Value of |
| Relationship Score | the Relationship With Contact |
| First Name | Contact's First Name |
| Last Name | Contact's Last Name |
| Full Name | Contact's Full Name |
| Primary Email | Contact's Primary Email |
| Primary Phone | Contact's Primary Phone |

In example embodiments, the basic data included in user data 28 stored at relationship data storage 100 may include, for each user 182 that has a relationship with a contact 192 at the account 190, user records that include some or all of the variable fields listed in the following Table 4, among other things:

TABLE 4
User Data Fields:

| Field | Field Description |
|---|---|
| User ID | Unique user identifier |
| Account ID | Account ID of the subject account |
| Department | Name of user's department in the |
| | enterprise organization |
| Title | Title/position of user within enterprise |
| | organization |
| User-Account | Score That Indicates Perceived Value of |
| Relationship Score | User's Relationship With Contact |
| Opportunity ID (*) | Opportunity ID for opportunity for |
| | which user is member of the enterprise |
| | team (e.g., selling team) |

In example embodiments, the basic data included in user-contact relationship data 30 stored at relationship data storage 122 may include, for each user-contact relationship that exists between a user 182 within enterprise 180 and a contact 192 within the account 190, user-contact relationship records that include some or all of the variable fields listed in the following Table 5, among other things:

TABLE 5
User-Contact Relationship Data Fields:

| Field | Field Description |
|---|---|
| User ID | Unique user identifier |
| Contact ID | Contact Unique Identifier |
| Start Date | Date when relationship between user |
| | and contact started |
| Active Indicator | Indicates if relationship is currently |
| | active |
| User-Contact | Score that indicates perceived strength |
| Relationship Score | of User-Contact Relationship Strength |
| Last Activity Date | Date of last recorded activity including |
| | user and contact |

In example embodiments, the activity data 32 stored at relationship data storage 122 may include data for activities related to the entity-account relationship. Activities may for example include communication activities and documentation activities among other things. Activity data 32 may include respective activity records (AR) 33 for each logged activity. Each activity record 33 may include, depending on the type of activity and availability of information, the variable fields listed in the following Table 6, among other things:

TABLE 6
Activity Data Fields:

| Field | Field Description |
|---|---|
| Activity ID | Unique identifier assigned to activity |
| Account ID | Identity of Account whose contacts |
| | participated in the activity |
| Opportunity ID | Identity of the opportunity that activity |
| | related to |
| Activity Type Indicator | Value that identifies the type of activity |
| | (e.g., (i) communication activity: |
| | incoming email, outgoing email, |
| | incoming meeting request, outgoing |
| | meeting request, incoming phone call, |
| | outgoing phone call, in-person meeting, |
| | virtual meeting, (ii) documentation |
| | activity: proposal submitted, draft |
| | statement of work (SOW) submitted; |
| | final SOW submitted; contract |
| | submitted for review). |
| Start Time | Date and time stamp indicating start of |
| | activity |
| Activity Duration | Duration of activity (e.g., length of |
| | meeting or phone call) |
| Participants - Account* | Contact IDs or other available identifier |
| | for all parties involved on account side |
| | of activity |
| Participants - Enterprise* | User IDs or other available identifier for |
| | all parties involved on enterprise side of |
| | activity |

*Indicates fields that will be repeated as required

In example embodiments, the CRM support system 120 is configured to log and record changes that occur in one or more of the variable fields so that changes in data can be tracked over time. In example embodiments, at some of the activity records 33, such as activity records generated in respect of communication activities, included in activity data 32, are generated and at least partially populated based on information generated through automated tracking of electronic events that occur at enterprise network 110. Some activity records 33, such as activity records generated in respect of document events, may in at least some example be generated in response to information provided by a user 182 through an interface supported by contact support agent 112, which is then relayed to CRM support system through communication network 150.

Regarding activity data 32, in example embodiments, contact support agent 112 is configured to automatically collect information about communication activities between users 182 associated with the enterprise 180 and external contacts 192 associated with an account 190. These communication activities may for example be electronic communications such as email, meetings that are tracked in calendar systems and/or scheduled through email communications, and telephone calls that occur through a system that enables call logging. Each of these interactions have associated electronic data that includes a contact identifier (e.g., email address or phone number for contact 192), time stamp information for the interaction, and a user identifier (e.g., data that identifies the member(s) 182 of the enterprise 180 that were involved in the interaction.

In example embodiments, contact support agent 112 is configured to collect the information about communication activities by interacting with devices and systems that are integrated with enterprise network 110 and generate reports that are sent to CRM support system 120 automatically on a scheduled basis or when a predetermined threshold is met or a predetermined activity occurs. In some examples, contact support agent 112 may collect information from an enterprise mail server located within enterprise network 110, and or from calendar applications associated with enterprise network and users 182.

It will be noted that a number of the data objects include relationship scoring information, including: Account Data 22 includes a “Top User-Account Relationship” that identifies the enterprise user 182 that has the strongest relationship with the subject account 190; Contact Data 26 includes a “Contact-Enterprise Relationship Score” that that indicates a total perceived value of the enterprise's 180 relationship with the subject contact 192; User Data 28 includes a “User-Account Relationship Score” that indicates perceived value of user's relationship with contact; and User-Contact Relationship Data includes a “User-Contact Relationship Score” that indicates perceived strength of the user-contact relationship. According to example embodiments, the CRM support system 120 is configured with a set of relationship strength prediction models for computing each of the respective relationship scores. In at least some examples, these scores are calculated by CRM support system 120 based on communication activities between enterprise users 182 and account contacts 192, such as the communications activities that are tracked as part of activity data 32. By way of example, the User-Contact Relationship Score for an enterprise user 182—account contact 192 could be based on features such as, among other things: activity type (e.g., incoming email, outgoing email, incoming meeting request, outgoing meeting request, incoming phone call, outgoing phone call, in-person meeting, on-line meeting, video conference); frequency (e.g., number of communication activities with a defined time period); recentness of communication activities; and length of communication activity, among other things. For example, a User-Contact Relationship Score could be quantified as a percentage (e.g., 0 to 100%) by applying a predetermined function, which may in some example be a deterministic linear rules-based model, and in other examples may be a trained non-linear predictive model. In example embodiments, a deterministic model may be derived by a data scientist based analysis of simulated data and real data using one or more statistical analysis methods. In some example embodiments, User-Contact Relationship Score could be represented as a discrete ranking such as “3=high”, “2=medium, “1=low”.

In some examples a User-Contact Relationship Score could be a composite of the contacts title score and a communication value based on the above attributes. In some examples, “Contact-Enterprise Relationship Score” could be based on a combination (e.g., sum or product) of all of the individual User-Contact Relationship Scores that a contact 192 has with users 182 of enterprise 180. In some examples, a “User-Account Relationship Score” could be based on a combination (e.g., sum or product) of all of the individual User-Contact Relationship Scores that a user 182 has with account contacts 192; In some examples, the “Contact-Enterprise Relationship Score” could be based on a combination of all the individual User-Contact Relationship Scores across all user-contact relationships between an enterprise 180 and an account 190.

As indicated in FIG. 1, the enterprise website 100 include an associated visitor listening module 102 (which for example could be a JavaScript engine), that identifies when a visitor connects to the enterprise website 100 as well as, but not limited to, the visitor's IP address, geolocation information from their browser, and any identifying information they may have entered into fields\forms on the website (such as name, phone number, email address), or visitation history for the IP. In example embodiments, visitor listening module 102 is configured to automatically contact a contact identification module 114 that is part of the contact support agent 112 located within enterprise network 110. Visitor listening module 102 sends information that it has collected in respect of visitor connection to website the 100 via a communication network 150 to the contact identification module 114. For examples, such information can include the visitor IP address, as well as information that is collected automatically by the visitor listening module such as time and duration of the visit, web pages viewed, page viewing duration for both the present visits, as well as logs for previous visits; number of visits, and other information that can be tracked by cookies. Additionally, any additional information provided by the visitor in response to information queries can also be returned.

The enterprise network 110 includes the contact support agent 112, and an electronic messaging system 410. The contact support agent 112 contains the contact identification module 114, a contact matching policy 118, a communication processing module 116, and a communication policy 119.

The predefined contact matching policy 188 can define threshold criteria that trigger when action is taken in respect of a website visit. The predetermined communication policy 119 defines a set of rules that specify how and to whom information about website visits is disseminated within an enterprise. This policy can be based on, but not limited to, contact company, region, industry type or title of contact (when it can be determined). This policy can also define the type of notification such as, but not limited to, email, text or private message on an electronic messaging system.

The contact identification module 114 is configured to determine if a visitor connection to the enterprise website 100 meets the contact matching policy 118. If the visitor connection does meet the policy then the contact identification module 114 causes a request to be sent through a network 150 to a 3^{rd} party data service 200. The request includes the website visitor's IP address received from the visitor listening module 102. 3^{rd} party data service 200 has a database of IP addresses that map to respective company names, and possible other information.

The 3^{rd} party data service 200 will return any matching information details 220s (e.g., company name and/or location associated with the IP address) to contact identification module 114 through network 150. Contact identification module 114 will utilize the information returned from the 3^{rd} party data service 200 to query the CRM Support System 120 to determine if there is account data 22 that corresponds to a company that matches the identified company, CRM support system 120. If there is account data 22, the CRM support system 120 can return information about the account selected from data objects 124 that correspond to the account.

In example embodiments where the information from the visitor listening module 102 also contains information that identifies a specific individual (e.g., if a website visitor enters information such as an email address, name or phone number), or if the 3^{rd} party data service 200 was able to match the visitor information it received to a specific individual identifier (e.g., email address, name or phone number) as well as a company name, then contact identification module 114 can use the individual identifier to query the CRM Support System 120 to determine if there is contact data 26 stored at relationship data 122 for a specific contact 192 that matches the individual identifier. If there is contact data 26, the CRM support system 120 can return information about the contact selected from the data objects 124 that correspond to the contact.

The contact identification module 114 will send the information to the communication processing module 116.

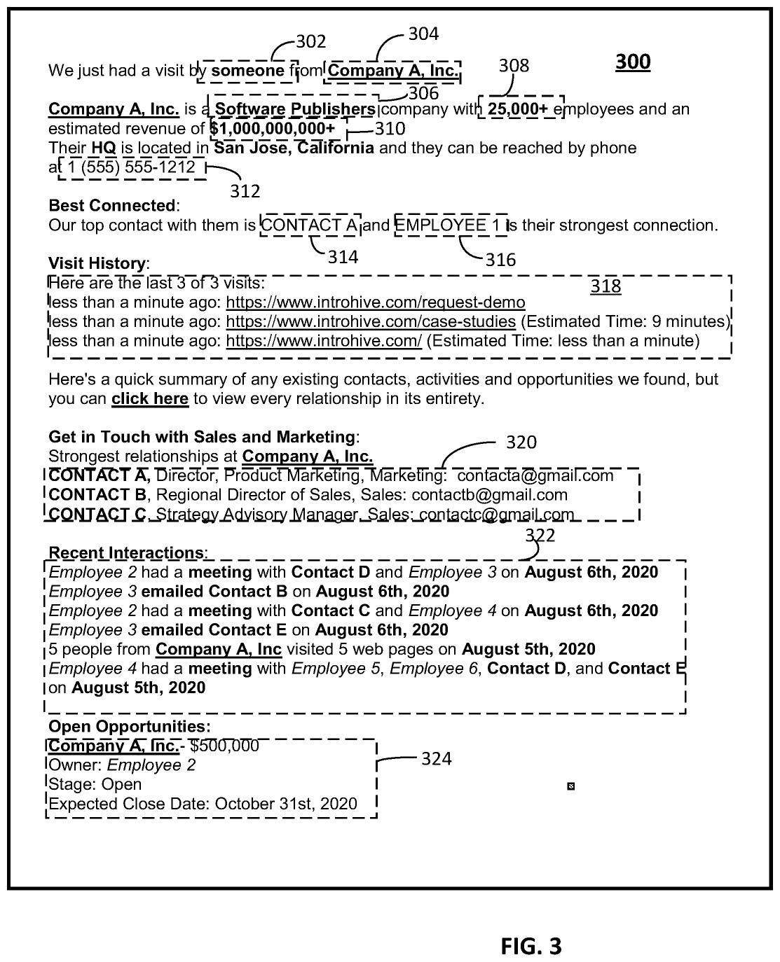

The communication processing module 116 will retrieve the communication policy 119 and create a communication with the information passed from the contact identification module 114. This communication may be, but not limited to, an email, a text to an individual 400, or a posting in an electronic messaging system 410. A sample communication 300 presented by the communication processing module 116 in accordance with the present embodiment is illustrated in FIG. 3.

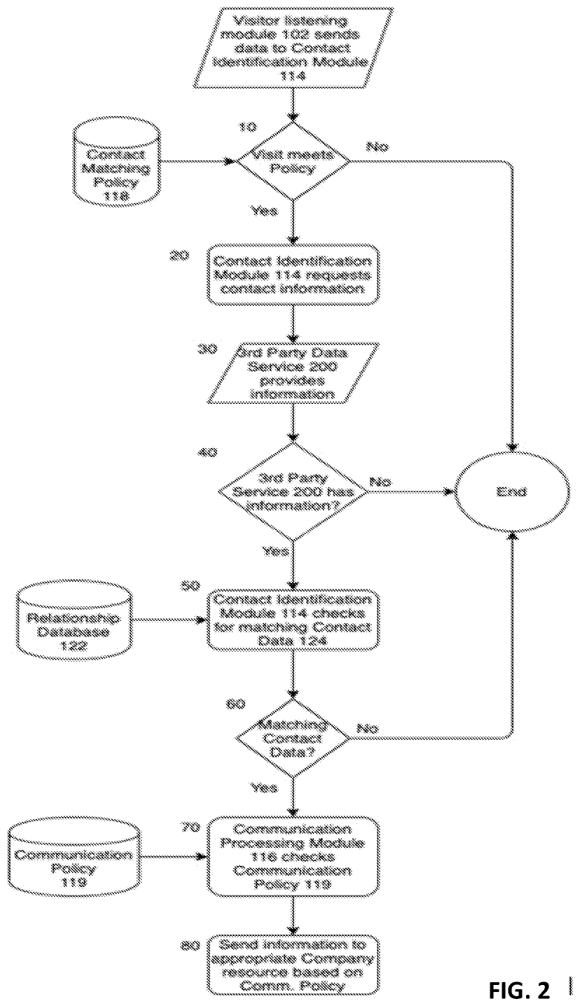

FIG. 2 is a flow diagram illustrating steps taken by the contact identification module 114 and the communication processing module 116 in accordance with an example embodiment of the present disclosure.

Step 10—The contact identification module 114 compares the contact matching policy 118 with the information received from the visitor listening module 102. The contact matching policy 118 could be, but not limited to: minimum number of web pages visited, minimum numbers of visits within a specified time period from the same IP address, minimum amount of time spent on the website, specific web pages visited or a combination thereof. If the visit does not meet the specified contact matching policy 116, then the example embodiment ends.

Step 20—If the website visitation meets the contact matching policy, the company identification module 114 will provide information to a 3^{rd} party data service 200 such as, but not limited to, the visitor's IP address or geolocation information from the visitor's Browser that was retrieved by the visitor listening module 102.

Step 30—The 3^{rd} party data service 200 determines if it has any additional data that matches the information provided from the contact identification module 114. If there is, the 3^{rd} party data service 200 returns the data such as, but not limited to, company name, geolocation information, and/or contact name. Note that in an alternative embodiment, the data services provided by 3^{rd} party data service 200 could be incorporated into an internal service within the enterprise network 110.

Step 40—The contact identification module 114 determines if the 3^{rd} party data service 200 provided additional information. If the 3^{rd} party data service 200 did not, the process ends.

Step 50—In example embodiments where the 3^{rd} party data service 200 provides additional data to the contact identification module 114, the contact identification module 114 determines if a matching account exists in account data 22, and if so company data from the relationship database 122 related to the specific information is provided to contact identification module 114.

In example embodiments, the visitor listening module 102 has have acquired additional identifying information based on data that the visitor may have entered into fields on the website such as, but not limited to, contact name, contact title, contact email address, contact industry, or contact phone number. In such cases, the contact identification module 114 may also query relationship data storage 122 for any contact data 26 that matches any individual identifying information included in relationship database 122 related to the specific information returned from the visitor listening module 102.

This data retrieved from the relationship database 122 by contact identification module 114 can include, but is not limited to, company names, contacts names, contacts emails, title of contacts, type of contacts, relationships, information on open opportunities that the enterprise has with the company, and the relationship scores noted above.

Step 60—In example embodiments where there is no matching account or contact data available in relationship data storage 122, the process ends.

Step 70—The communication processing module 116 reviews the communication policy 119 to determine if there are communication policies that apply to the information received from the contact identification module 114. In example embodiments, the communication policy 119 may identify restrictions such as, but not limited to: communication rules defining who receives notification based on (but not limited to) contact company, region, industry type, relationship strengths, privacy policies, or opportunity. These restrictions can also define the type of notification method such as, but not limited to, email, text, or message on an electronic messaging system 410.

In some examples, the process may terminate if the website visitor is deemed to have too low of a “Contact-Enterprise Relationship Score”, or if the account that the visitor is associated with has too low of a “Contact-Enterprise Relationship Score”, as determined by predefined thresholds. In some examples, could be based on a combination of all the individual User-Contact Relationship Scores across all user-contact relationships between an enterprise 180 and an account 190.

Step 70—In example embodiments the communication processing module 116 may further determine, from the data retrieved in Step 50 from the relationship database 122, the best enterprise resource to notify. This determination may be based on, but not limited to, the enterprise user 182 having strongest relationship with the account or the individual contact, the enterprise user 182 leading a current opportunity with the contact/company, or the enterprise user 182 responsible for the region or industry of the contact/company.

In some examples, the communication policy 119 may specify that a notification be posted to an internal company message board or electronic messaging system. The communication policy 119 may define who receives notification of the website visit. This policy can be based on, but not limited to, Contact Company, Region, Industry Type or Title of Contact. This policy can also define the type of notification such as, but not limited to, Email, Text or private message on an electronic messaging system.

Step 80—The communication processing module 116 will then automatically create a notification, based on the communication policy 119, and either deliver the notification to an enterprise resource 400 through an electronic medium or an electronic messaging system 410 and provide the available information about the current website visit. FIG. 3 provides an example notification 300.

The example notification 300 may for example include: 1) Contact name field 302 (Source: visitor listening module 102 and/or data service 200); 2) Company/Account name field 304 (Source: data service 200); 3) Account industry type field 304, number of employees field 308, annual revenue field 310 and phone number fields 312 (Source: Account data 22 of relationship data storage 122); 4) Top connected contact field 314 and top connected user field 316 (Source: contact data 26, user data 28, user-contact relationship data 30 and related relationship scores stored in relationship data storage 122); 5) Website visit history field 318 (Source: visitor listening module 102) 6) Contacts, ranked by relationship score fields 320 (Source: contact data 26, user-contact relationship data 30 and related relationship scores stored in relationship data storage 122); 7) Recent Enterprise-Account activities summary field 322 (Source: activity data 32 stored in relationship data storage 122) and 8) Open Enterprise-Account opportunities field (Source: opportunity data 24 stored in relationship data storage).

It will be appreciated that the described system and method allows information about a website vister to be automatically captured, and subjected to an initial filtering based on a matching policy that sets threshold criteria. If the initial filtering criteria is met, further identifying information (e.g., company name, contact name) is automatically sought from a further source (databases 210s). Based on that further identifying information, a query is made to yet a further data source (CRM support system 12) for additional information about a company (i.e. account) and/or individual contact that was identified as a participant in the website visit. This additional information is automatically processed and then disseminated within the enterprise 180 in accordance with rules specified in communication policy 119. This automated procedure may in at least some examples ensure that enriched information can be automatically collected in respect of a website visit and automatically directed to the appropriate individuals within enterprise 180.

Accordingly, the disclosure presents the following computer implemented method performed by contact support agent 112 according to example embodiments: receiving, from a first automated service (e.g., the visitor listening module 102 of enterprise website 100), identifying information (e.g., an IP address) for a website visitor; requesting, from a second automated service (e.g., 3^{rd} party data service 200), further identifying information (e.g., a corporate entity name) based on the received identifying information; when further identifying information is received from the second automated service, providing a query to a customer data storage system 120 for an account that matches the further identifying information; and when a positive response to the query indicating a match is received from the customer data storage system 120, causing a notification 300 to be generated that includes information included in the positive response.

In some examples, the identifying information for the website visitor is an IP address, and the further identifying information includes an entity name associated with the IP address. In some example embodiments, information about viewing activities by the website visitor are also received and the method includes determining if the viewing activities correspond to a predetermined criteria threshold. When the viewing activities do not correspond to the predetermined criteria threshold, requesting the further identifying information is not performed. When the viewing activities do correspond to the predetermined criteria threshold, the further identifying information is requested.

In some examples, the positive response includes information indicating an individual user having a preexisting relationship with the entity associated with the website visit, the method comprising automatically providing the notification 300 through an electronic medium (e.g., email or an GUI) to the indicated user.

In some examples, the indicated user corresponds to a user having the strongest perceived relationship with the entity based on a tracked communication history between the indicated user and the entity.

In some examples, the positive response includes information indicating an ongoing opportunity with an entity associated with the website visit, the method comprising including an identification of the ongoing opportunity in the notification.

In some examples the website is a website for an enterprise, the first automated service comprises a website visitor listening module, the second automated service comprises an IP address to entity name mapping service, wherein the computer implemented method is performed at a client network, and wherein the client network, the second automated service and the customer data storage system are each located behind respective fire walls and the client network communicates with each of the second automated service and the customer data storage system through the Internet.

In some examples, at least one of the identifying information and the further identifying information includes an identifier for an individual contact, wherein the query to the customer data storage system also includes a query for an individual contact that matches the identifier for the individual contact.

In some examples, the positive response to the query also includes an identification of a user who has an existing relationship with individual contact. In some examples, the positive response to the query also includes an indication of a relationship strength between the identified user and the individual contact that is based on a tracked communication history between the identified user and the individual contact.

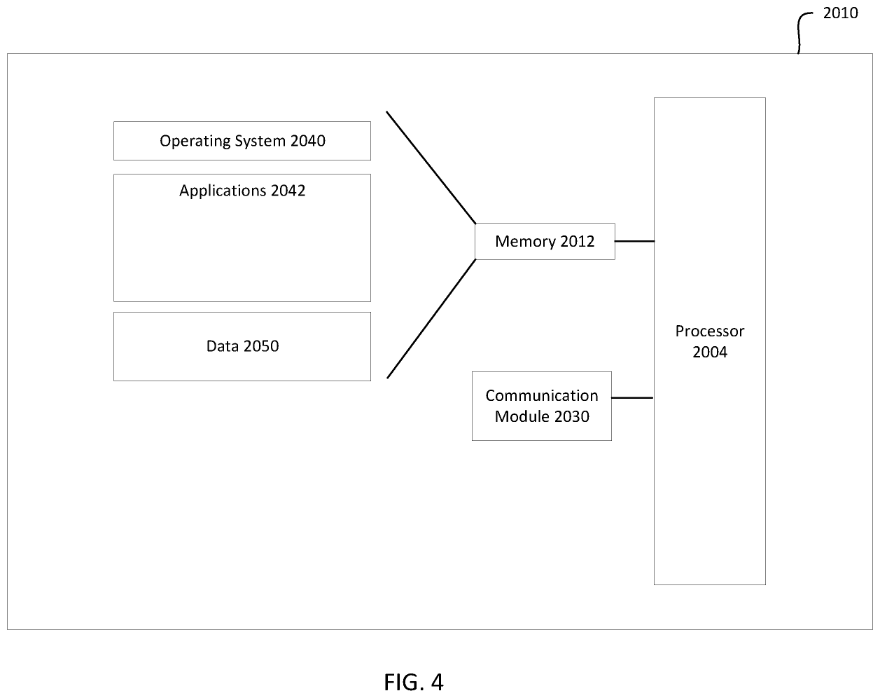

Referring to FIG. 4, an example embodiment of a computer system 2010 for implementing one or more of the modules, systems and agents included in enterprise network 110, CRM support system 120, and server 101 will be described. In example embodiments, computer system 2010 may be a computer server. The system 2010 comprises at least one processor 2004 which controls the overall operation of the system 2010. The processor 2004 is coupled to a plurality of components via a communication bus (not shown) which provides a communication path between the components and the processor 2004. The system comprises memories 2012 that can include Random Access Memory (RAM), Read Only Memory (ROM), a persistent (non-volatile) memory which may one or more of a magnetic hard drive, flash erasable programmable read only memory (EPROM) (“flash memory”) or other suitable form of memory. The system 2010 includes a communication module 2030.

The communication module 2030 may comprise any combination of a long-range wireless communication module, a short-range wireless communication module, or a wired communication module (e.g., Ethernet or the like) to facilitate communication through communication network 150.

Operating system software 2040 executed by the processor 2004 may be stored in the persistent memory of memories 2012. A number of applications 202 executed by the processor 2004 are also stored in the persistent memory. The applications 2042 can include software instructions for implementing the systems, methods, agents and modules described above.

The system 2010 is configured to store data that may include data objects 124.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure. All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A computer implemented method, comprising:
receiving, from a first automated service, identifying information for a website visitor;
requesting, from a second automated service, further identifying information based on the received identifying information;
when further identifying information is received from the second automated service, providing a query to a customer data storage system for an account that matches the further identifying information; and
when a positive response to the query indicating a match is received from the customer data storage system, causing a notification to be generated that includes information included in the positive response.

2. The method of claim 1 wherein the identifying information for the website visitor is an IP address, and the further identifying information includes an entity name associated with the IP address.

3. The method of claim 2 wherein information about viewing activities by the website visitor are also received, the method including:
determining if the viewing activities correspond to a predetermined criteria threshold;
when the viewing activities do not correspond to the predetermined criteria threshold, forgoing requesting the further identifying information; and
when the viewing activities do correspond to the predetermined criteria threshold, requesting the further identifying information.

4. The method of claim 1 wherein the positive response includes information indicating an individual user having a preexisting relationship with the entity associated with the website visit, the method comprising automatically providing the notification through an electronic medium to the indicated user.

5. The method of claim 4 wherein the indicated user corresponds to a user having the strongest perceived relationship with the entity based on a tracked communication history between the indicated user and the entity.

6. The method of claim 1 wherein the positive response includes information indicating an ongoing opportunity with an entity associated with the website visit, the method comprising including an identification of the ongoing opportunity in the notification.

7. The method of claim 1 wherein the website is a website for an enterprise, the first automated service comprises a website visitor listening module, the second automated service comprises an IP address to entity name mapping service, wherein the computer implemented method is performed at a client network, and wherein the client network, the second automated service and the customer data storage system are each located behind respective fire walls and the client network communicates with each of the second automated service and the customer data storage system through the Internet.

8. The method of claim 1 wherein at least one of the identifying information and the further identifying information includes an identifier for an individual contact, wherein the query to the customer data storage system also includes a query for an individual contact that matches the identifier for the individual contact.

9. The method of claim 8 wherein the positive response to the query also includes an identification of a user who has an existing relationship with individual contact.

10. The method of claim 9 wherein the positive response to the query also includes an indication of a relationship strength between the identified user and the individual contact that is based on a tracked communication history between the identified user and the individual contact.

11. A computer system comprising a processor and persistent storage storing computer instructions that when executed by the processor configure the computer system to:
receive, from a first automated service, identifying information for a website visitor;
request, from a second automated service, further identifying information based on the received identifying information;
when further identifying information is received from the second automated service, provide a query to a customer data storage system for an account that matches the further identifying information; and
when a positive response to the query indicating a match is received from the customer data storage system, cause a notification to be generated that includes information included in the positive response.

12. The computer system of claim 11 wherein the identifying information for the website visitor is an IP address, and the further identifying information includes an entity name associated with the IP address.

13. The computer system of claim 11 wherein information about viewing activities by the website visitor are also received, and the computer system is configured to:
determine if the viewing activities correspond to a predetermined criteria threshold;
when the viewing activities do not correspond to the predetermined criteria threshold, forgoing requesting the further identifying information; and
when the viewing activities do correspond to the predetermined criteria threshold, requesting the further identifying information.

14. The computer system of claim 11 wherein the positive response includes information indicating an individual user having a preexisting relationship with the entity associated with the website visit, and the computer system is configure to automatically provide the notification through an electronic medium to the indicated user.

15. The computer system of claim 14 wherein the indicated user corresponds to a user having the strongest perceived relationship with the entity based on a tracked communication history between the indicated user and the entity.

16. The computer system of claim 15 wherein the positive response includes information indicating an ongoing opportunity with an entity associated with the website visit, the computer system being configured to include an identification of the ongoing opportunity in the notification.

17. The computer system of claim 11 wherein at least one of the identifying information and the further identifying information includes an identifier for an individual contact, wherein the query to the customer data storage system also includes a query for an individual contact that matches the identifier for the individual contact.

18. The computer system of claim 17 wherein the positive response to the query also includes an identification of a user who has an existing relationship with individual contact.

19. The computer system of claim 18 wherein the positive response to the query also includes an indication of a relationship strength between the identified user and the individual contact that is based on a tracked communication history between the identified user and the individual contact.

20. A non-volatile digital storage medium storing computer instructions that when executed by a processor configure the processor to:
receive, from a first automated service, identifying information for a website visitor;
request, from a second automated service, further identifying information based on the received identifying information;
when further identifying information is received from the second automated service, provide a query to a customer data storage system for an account that matches the further identifying information; and
when a positive response to the query indicating a match is received from the customer data storage system, cause a notification to be generated that includes information included in the positive response.
